(19) United States
(12) Patent Application Publication
(10) Pub. No.: US 2012/0040081 A1
(43) Pub. Date: Feb. 16, 2012

(54) Food preparations for cooking in micro-wave ovens, with solidified vegetable oil, and procedure for their elaboration

(76) Inventor: Juan Ramón Durán Vila, Reus (ES)

(21) Appl. No.: 13/136,062

(22) Filed: Jul. 21, 2011

(30) Foreign Application Priority Data
Apr. 1, 2008 (ES) 200800898

(51) Int. Cl. A23L 1/18

(52) U.S. Cl. 426/625

(57) ABSTRACT

Food preparations for cooking in micro-wave ovens, with solidified vegetable oil, and procedure for their elaboration.

Food preparations are described containing vegetable oil solidified at room temperature, packed specially for cooking in micro-wave ovens, and a procedure for their elaboration. The composition of the food preparations comprises mainly popcorn, vegetable oil, oil solidifying agent and possibly other optional ingredients, such as sugar, salt, aromatics, flavourings, colours and preserving agents.

The elaboration procedure is based on the batching of corn in a special wrapper for microwave cooking, and then the batching of the other ingredients, previously mixed consistently and according to the individual formulations of each food preparation, under thermal control at a temperature of 50-70° C.

### OBJECT OF THE INVENTION

The present invention is directed at food preparations for cooking in micro-wave ovens, with solidified vegetable oil, and a procedure for their elaboration, offering essential features of inventive novelty and inventive activity with regards to means and procedures known and used for equivalent purposes in the prior art.

In particular, the invention refers, first of all, to food preparations involving the use of different ingredients, one of which is solidified vegetable oil, present in each and every one of these preparations, and which underlies the basis of this invention.

The invention is especially aimed at a range of food preparations involving the use of a set of fixed ingredients and a set of optional ingredients in accordance with the specific preparation in question. The fixed ingredients comprise:
popcorn or extrusion product (hereinafter referred to as snack);
a vegetable oil, and
an oil solidifying agent (hereinafter ME)
   while the optional ingredients may be chosen from amongst the group comprising:
flavours:
colours;
salt;
sweeteners;
sugar, and
preserving agents.

Secondly, the invention refers also to a procedure for the elaboration of food preparations, as well as for the nutritional enhancement that they offer in relation to those of the same type already existing on the market

The field of application of the invention is obviously comprised in the industrial sector given over to the manufacture of food compounds for subsequent preparation in micro-wave ovens.

To achieve the notable reduction in SFA in the food preparation, the invention uses highly unsaturated vegetable oil, to which a likewise vegetable product (ME) is added, so that a lipid compound is obtained which is solid at temperatures below 40° C., but which contains around 50% SFA and approximately a quarter of the TFA content presented by a fat of those normally found on the market and which has an equivalent melting point.

Thus, a fat with a low percentage of saturated fatty acids (SFA), i.e. with a high percentage of unsaturated fatty acids (UFA), presents such advantages as:
contributing to lowering the cholesterol and LDL (low-density lipoprotein) level, and
contributing to raising the HDL (or good cholesterol) level.

### DESCRIPTION OF A PREFERRED EMBODIMENT OF THE INVENTION

The present invention refers to a range of food products prepared for cooking in micro-wave ovens. The main feature of the invention refers to the fact that the food product presents an amount of saturated fatty acids far below the amounts usually present in the products of the same type currently on the market. In addition, depending on the vegetable oil used, we may obtain a flavour typical of certain oils highly appreciated in the Mediterranean diet, as is the case of olive oil.

Specifically, the food products referred to consist, in each case, of a composition on the basis of the ingredients that are specified below:

| | Presence of the ingredient | | |
|---|---|---|---|
| | in the food products | | Batching |
| | In each | | of the ingredient |
| Ingredient | preparation | Optional | in the food product |
| Popcorn or snack | X | | 50 to 90 |
| Liquid vegetable oil | X | | 10 to 50 |
| Solidifying agent (ME) | X | | 1 to 8 |
| Salt | | X | <5 |
| Sugar | | X | <15 |
| Colours | | X | ≦200 ppm* |
| Sweeteners | | X | <2* |
| Flavours | | X | <7* |
| Aromatics | | X | <7* |
| Preserving agents | | X | ≦200 ppm* |

*According to current legislation

The batching amounts are expressed in percentages in weight, unless defined otherwise.

The different compositions of the invention are presented packaged in a Kraft type paper bag designed especially for micro-wave ovens.

The composition of the lipid mix of the food preparations has as its main ingredient a vegetable oil with a proportion of saturated fatty acids of 30% or less. This characteristic is mainly complied with by the following vegetable oils:

| Vegetable Oils | % SFA |
|---|---|
| Almond | 7 |
| Gashew nut | 18 |
| Hazelnut | 5 |
| Peanut | 15 |
| Cannabis | 8 |
| Canola | 6 |
| Cartamo | 10 |
| Brazil nut | 16 |
| Wheat germ | 18 |
| Sunflower seed | 13 |
| Sunflower seed AO | 10 |
| Linseed | 9 |
| Macadamia nut | 12 |
| Corn | 13 |
| Walnut | 16 |
| Olive | 14 |
| Primrose | 11 |
| Pecan | 7 |
| Grapeseed | 12 |
| Pine nut | 8 |
| Pumpkin seed | 9 |
| Pistachio nut | 6 |
| Apricot kernel | 10 |
| Cotton seed | 25 |
| Sesame | 13 |
| Soybean | 15 |

The special feature of any of these oils consists of the fact that they offer a great nutritional advantage, in view of their level of unsaturation, as mentioned previously. However, they have the drawback, technologically speaking in respect of the end products, that all these oils are liquid at ambient temperature, so that with time they filter past the Kraft paper making up the primary packaging, in detriment to the commercial presentation of the end product.

The present invention has provided a clearly successful solution to this drawback, since the liquid vegetable oil is presented in solidified form by combining it with a lipid agent of a vegetable nature (ME), forming a fatty compound capable of solidifying at temperatures below 40° C., and which will only liquefy at temperatures above 55° C.

In this way, with any of the oils belonging to the group listed in the preceding table, we obtain food compositions for micro-wave ovens with an approximately 50% reduction in SFA and 75% in TFA compared with the same composition obtained from regularly used vegetable fats.

With regard to the procedure for elaboration of food preparations corresponding to the present invention, it comprises the sequence of stages set out below:
1) batching the corn or snack inside the individual paper bags, at the rate of 50-90% in weight of the food preparation;
2) batching inside each paper bag of the mixture of vegetable and solidifying agent (ME), together with one of more of the other ingredients, at the rate of a proportion of 10-50% in weight of the food preparation, in accordance with each individual formulation; this batching is done at between 50-70° C.;
3) batching, as required, inside each paper bag of the remaining optional ingredients in a uniform mixture, in varying amounts depending on each formulation and proportion in weight of the food preparation;
4) heat sealing of the mouth of the paper bag;
5) tri-folding of the paper bags, filled with all the ingredients of the formulation, and
6) packing of each folded paper bag, in a heat-weldable plastic complex.

As will be understood, the procedure that has just been described makes food preparations commercially available to consumers, contained in perfectly protected packs, with food products that include a vegetable oil solidified at room temperature and especially suitable for cooking in micro-wave ovens.

1. Food preparations for cooking in micro-wave ovens with solidified vegetable oil, which comprise a set of ingredients packaged in Kraft paper bags, included amongst which are popcorn and vegetable oil as fixed ingredients and other optional ingredients chosen from the group consisting of flavours, colours, salt, sweeteners, sugar and preserving agents, characterised in that the vegetable oil present in the preparation consists of a combination of previously selected vegetable oil with an oil solidifying agent. This combination provides a lipid compound solid at room temperature and with a low saturated fatty acid and trans fatty acid content in which the proportion of saturated fatty acids is less than 27% in weight.

2. Preparations according to claim 1, characterised in that the fatty compound solidifies below 40° C., its melting point being in the order of 55° C.

3. Preparations according to claims 1 and 2, characterised in that the starting vegetable oil is chosen from the group comprising liquid almond, cashew nut, hazelnut, peanut, cannabis, canola, cartamo, Brazil nut, wheat germ, sunflower seed, sunflower seed AO, linseed, macadamia, corn, walnut, olive, primrose, pecan, grape seed, pine nut, pumpkin seed, pistachio nut, apricot kernel, cotton seed, sesame and soybean vegetable oils.
